(19) United States
(12) Patent Application Publication
(10) Pub. No.: US 2006/0017868 A1
(43) Pub. Date: Jan. 26, 2006

(54) Apparatus of liquid crystal display for compensating chromaticity of reflected light and the method of fabrication

(75) Inventor: Po-Hsien Wang, Taichung City (TW)

Correspondence Address: BACON & THOMAS, PLLC, 625 SLATERS LANE, FOURTH FLOOR, ALEXANDRIA, VA, 22314, US

(73) Assignee: Wintek Corporation, TAICHUNG (TW)

(21) Appl. No.: 10/896,925

(22) Filed: Jul. 23, 2004

(51) Int. Cl. G02F 1/1335

(52) U.S. Cl. 349/113; 349/114

(57) ABSTRACT

A liquid crystal penal has a lower color filter film, a reflective film, an upper color filter film, a protective layer (with or without), a lower transparent electrode and an upper glass substrate with an upper transparent electrode on a bottom thereof stacked on the on a lower glass substrate in sequence. And then, a liquid crystal layer is provided in between the upper and the lower transparent electrode. The liquid crystal penal of the present invention provides a higher color intensity and a greater luminance.

### BACKGROUND OF THE INVENTION

1. Field of the Invention

The present invention relates generally to a liquid crystal display (LCD), and more particularly to an apparatus of a liquid crystal panel for compensating chromaticity of the reflected light and the method of fabrication.

2. Description of the Related Art

As shown in FIG. 1, a conventional color liquid crystal panel has an upper glass substrate 1 and a lower glass substrate 2 between which a liquid crystal layer 3, a protective layer 4, a filter layer 5 and reflective layer 6 are mounted. The reflective layer 6 has a plurality of total-reflection regions 6a and apertures 6b. A backlight module 7 is mounted behind the lower glass substrate 2 to complete a transflecitve liquid crystal display. The panel can be respectively provided with a polarizing plate (not shown) on opposite sides thereof for various requirements.

While the transflective liquid crystal display shows an image under a reflective mode, lights will travel through the filter layer 5 twice. The conventional filter layer 5 is made of a color resin material with a lower color intensity to reduce the light resistance thereof and increase the penetrability thereof. But such filter layer provides a poor color intensity. On the contrary, the filter layer 5 can be made of a color resin material with a high color intensity, but the higher light resistance makes it having a poor illumination. Same situation happens to the light provided from the backlight module 7 traveling through the filter layer 5 once.

To fix the drawback, a six-color method is invited to fabricate a liquid crystal penal. As shown in FIG. 2, the penal has an upper glass substrate 1 and a lower glass substrate 2 between which a liquid crystal layer 3, a protective layer 4, a filter layer 8 and reflective layer 6 are mounted. The filter layer 8 has a first filter film 8a, which is made of a color resin material with a lower color intensity and is provided on total-reflection regions 6a of the reflective layer 6 for reflection, and a second filter film 8b, which is made of a color resin material with a lower color intensity and is provided in apertures 6b of the reflective layer 6 for passing light. The first and the second filter film 8a and 8b has different light resistances to make the panel having a well light penetrability while it shows an image under a light reflection condition and has a well color intensity while it shows an image under a light penetration condition.

However, the first and the second filter film 8a and 8b is arranged in parallel and alternate so that the widths thereof are only half of the original design. It also has drawbacks of hard to align because of the narrow widths thereof and a thickness of the first filter film 8a is restricted to keep the filter layer 8 having a flat surface. These drawbacks make the penal having a greater defective in fabrication and hard for mass production.

### SUMMARY OF THE INVENTION

The primary objective of the present invention is to provide an apparatus and a method, which the filter layer has two stacked color filter films to make them easy to align and to reduce the defective of fabrication.

The secondary objective of the present invention is to provide an apparatus and a method, which the filter layer is capable of increasing the color intensity and luminance.

According to the objectives of the present invention, a liquid crystal penal has a lower color filter film, a reflective film, an upper color filter film, a lower transparent electrode and an upper glass substrate with an upper transparent electrode on a bottom thereof stacked on the on a lower glass substrate in sequence, and then a liquid crystal layer is provided in between the upper and the lower transparent electrode.

### BRIEF DESCRIPTION OF THE DRAWINGS

FIG. 1 is a sectional view of a conventional liquid crystal penal;

FIG. 2 is a sectional view of another conventional liquid crystal penal;

FIG. 3 is a flow chart of the method of a first preferred embodiment of the present invention;

FIG. 4A to FIG. 4L are sectional views of the first preferred embodiment of the present invention, showing the steps of fabrication;

FIG. 5 is a sectional view of the first preferred embodiment of the present invention, showing the light paths;

FIG. 6A to FIG. 6L are sectional views of a second preferred embodiment of the present invention, showing the steps of fabrication;

FIG. 7 is a sectional view of the second preferred embodiment of the present invention, showing the light paths;

FIG. 8 is a sectional view of the penal of the present invention, which there is no protective layer provided and the reflective layer has the apertures;

FIG. 9 is a sectional view of another penal of the present invention, which there is no protective layer provided and the reflective layer is total covered, and

FIG. 10 is a sectional view of a third preferred embodiment of the present invention.

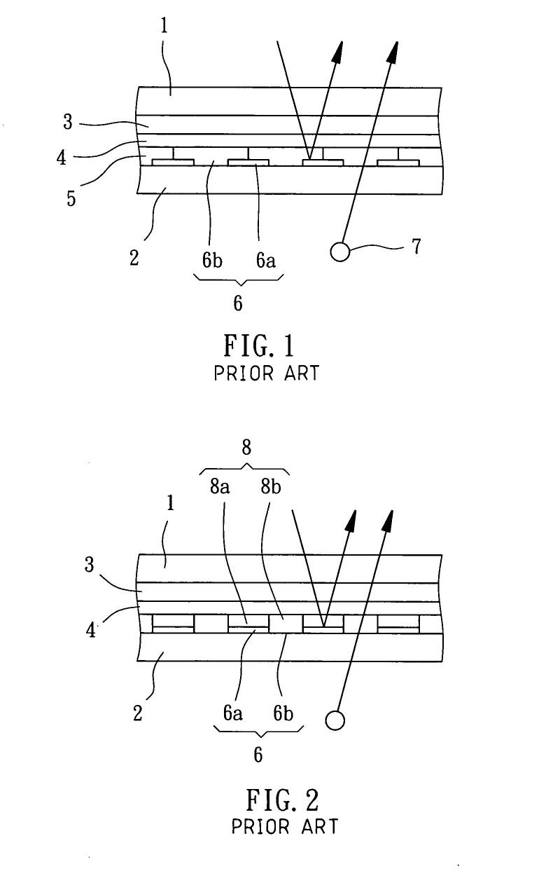

### DETAILED DESCRIPTION OF THE INVENTION

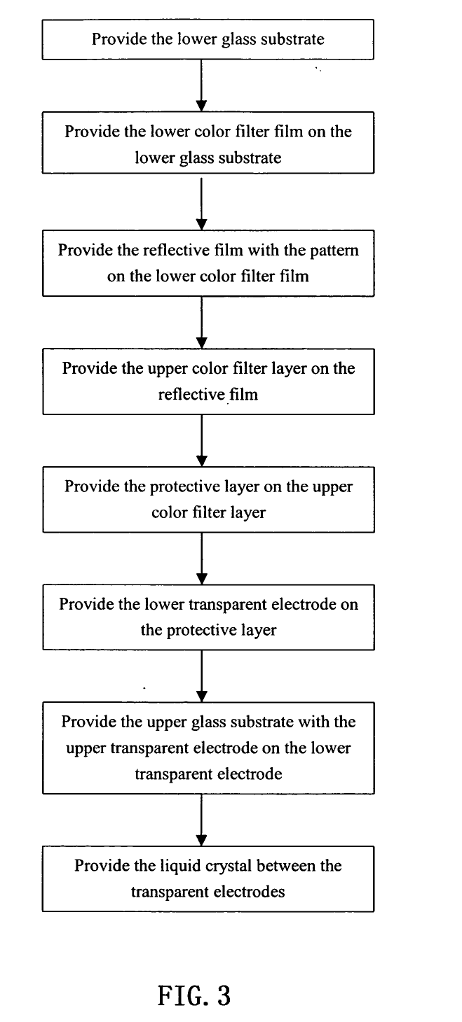

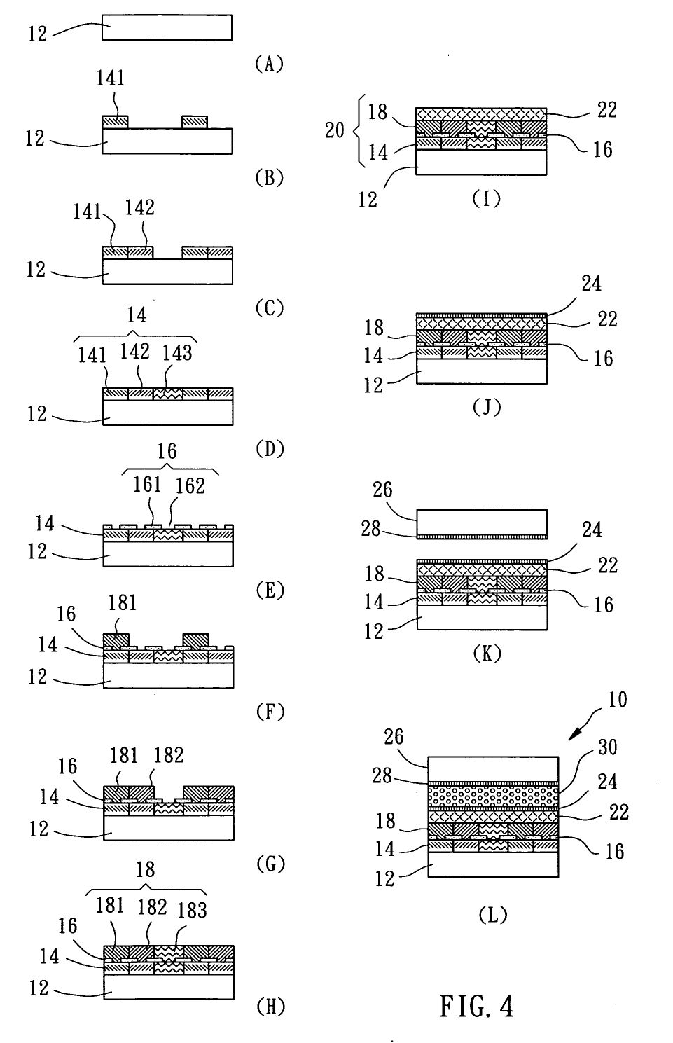

As shown in FIG. 3 and FIG. 4, a method of making a liquid crystal panel 10, which is capable of compensating the chromaticity of the reflected light, comprises the steps:
a) Provide a lower glass substrate 12, as shown in FIG. 4A.
b) Provide a lower color filter film 14:

As shown in FIGS. 4B, 4C and 4D, the photolithography method and curing are applied to provide red-light sensitive members 141, green-light sensitive members 142 and blue-light sensitive members 143 on the lower glass substrate 12 to form the lower color filter film 14. The lower color filter film 14 has a thickness between 300 nm and 3000 nm. The sensitive members are made of color resin materials with high color intensity.
c) Provide a reflective film 16 on the lower color filter film 14:

As shown in FIG. 4E, the reflective film 16 is made of a film with gold, silver, copper, aluminum, palladium or the alloy or is made of a multi-layer film of nonmetallic materials. The reflective film 16 is made from the photolithography method and has a thickness between 10 nm and 1000 nm. The reflective film 16 has a plurality of total-reflection regions 161 and apertures 162. The reflective film 16 has an aperture ratio between 5% and 80%.
d) Provide an upper color filter film 18 on the reflective film 16:

As shown in FIGS. 4F, 4G and 4H, the photolithography method is applied again to provide red-light sensitive members 181, green-light sensitive members 182 and blue-light sensitive members 183 on the reflective film 16 to form the upper color filter film 18. The upper color filter film 18 has a thickness between 300 nm and 3000 nm. The sensitive members 181, 182 and 183 are made of color resin materials with color intensities less than the color intensities of the sensitive members 141, 142 and 143 of the lower color filter film 14. The upper and the lower filter films 14 and 18 complete a color filter layer 20.
e) Provide a protective layer 22 on the upper color filter film 18:

As shown in FIG. 41, a resin material is coated on the upper color filter film 18 to form the protective layer 22 with a flat surface.
f) Provide a lower transparent electrode 24 on the surface of the protective layer 22, as shown in FIG. 4J.
g) Provide an upper glass substrate 26 with an upper transparent electrode 28 on a bottom side thereof on the lower transparent electrode 24, as shown in FIG. 4K.
h) Provide a liquid crystal layer 30:

As shown in FIG. 4L, a liquid crystal is provide to where between the upper transparent electrode 28 and the lower transparent electrode 24 to form the liquid crystal layer 30. A phase difference And of the liquid crystal layer 30 is in a range between 100 nm and 900 nm. For a STN-LCD, the phase difference And is preferred in a range between 700 nm and 900 nm.

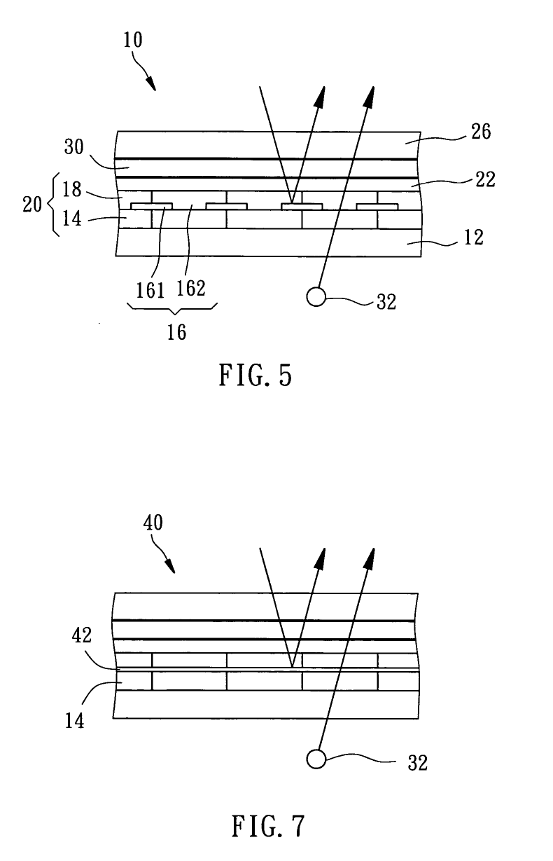

After these steps, the liquid crystal penal 10 of the first preferred embodiment of the present invention is shown in FIG. 5. In the penal 10, the filter layer 20 is consisted of the upper and the lower color filter films 18 and 14 stacked and the upper and the lower color filter films 18 and 14 is made of the materials with different color intensities. The red-light sensitive member 181 of the upper color filter film 18 aligns the red-light sensitive member 141 of the lower color filter film 14. Same as the green-light and blue-light sensitive members 182 and 183 of the upper 18, they align the green-light and blue-light sensitive members 142 and 143 of the lower color filter film 14. In practice, the penal 10 is provided with a backlight module behind the lower glass substrate 12. The penal 10 is laminated with two polarizing plates (not shown) on the upper and the lower glass substrates 26 and 12 respectively to meet various requirements.

As shown in FIG. 5, in the light reflection mode, a light in front of the upper glass substrate 26 traveling through the upper glass substrate 26 is reflected by the total-reflection regions 161 after it travels through the upper color filter film 18 and the reflected light travels through the upper color filter film 18 again. Because the upper color filter film 18 is made of the color resin material with lower color intensity, the reflected light has a well luminance. In the light penetration mode, a light provided from the backlight module 32 travels through the lower color filter film 14 and the apertures 162 of the reflective film 16, and then traveling out of the penal 10. Because the lower color filter film 14 is made of the color resin material with higher color intensity and the red-light, the green-light and the blue-light sensitive members 181, 182 and 183 of the upper color filter film 18 align the red-light, the green-light and the blue-light sensitive members 141, 142 and 143 of the lower color filter film 14 respectively, the light still has a well color intensity even through the light has to travel through the upper color filter film 18.

If the penal 10 of the present invention is installed in the STN-LCD, the display provides a higher color intensity and a greater luminance under the interaction of the light reflection mode and the light penetration mode.

The advantages of the penal 10 of the present invention are:

1. The red-light, the green-light and the blue-light sensitive members 181, 182 and 183 of the upper color filter film 18 align the red-light, the green-light and the blue-light sensitive members 141, 142 and 143 of the lower color filter film 14 respectively. It fixes the drawback of the conventional color filter layer made from the six-color method, which the parallel filter films are hard to be aligned. The method of present invention, therefore, reduces the defective of fabrication.

2. The color filter layer 20 of the present invention has a flat surface and the sensitive members of the color filter films 14 and 18 are arranged in order, so that the penal 10 made of the method of the present invention provides a higher color intensity and a greater luminance.

3. The thickness of the upper color filter film 18 of the filter layer 20 is designated to increase the light reflection.

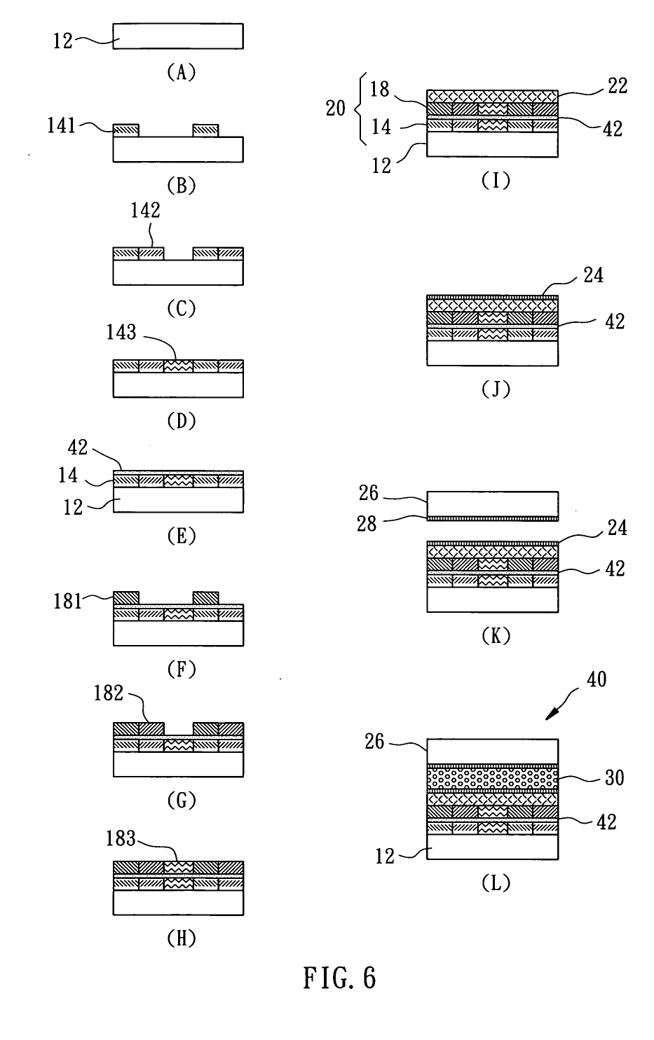

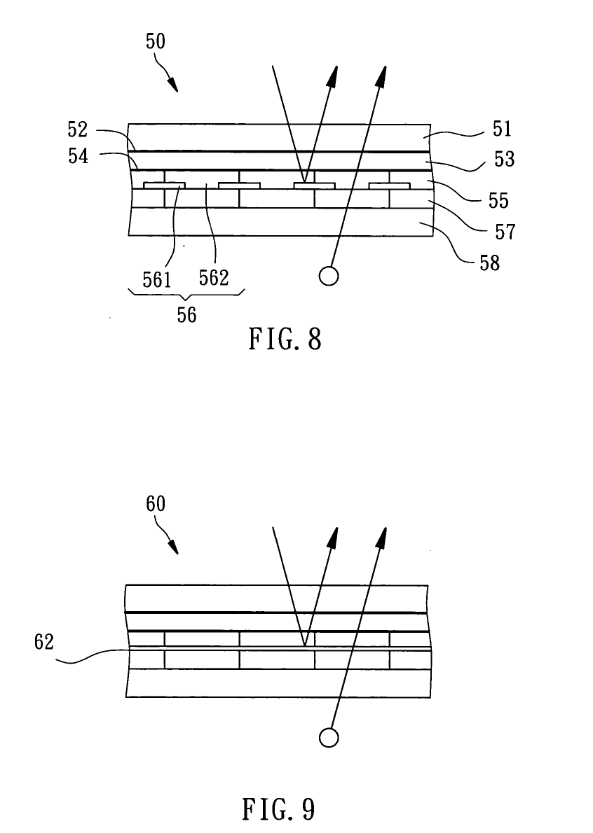

FIG. 6 and FIG. 7 show a penal 40 of the second preferred embodiment of the present invention. FIG. 6A to FIG. 6L show the steps of a method making the penal 40, which is similar to the method of the first preferred embodiment as described above, except that, in FIG. 6E, a reflective film 42 with a thickness between 5 nm and 200 nm is totally covered on a top side of the lower color filter film 14. The reflective film 42 serves both functions of passing light through and reflecting light. FIG. 7 shows the penal 40 works under both of the light reflection mode and the light penetration mode, and it still provides a higher color intensity and a greater luminance as the penal 10 of the first preferred embodiment does.

In addition, in the process of making the penal of the present invention, the penal is provided with or without the protective layer for various products, such as TN type LCD. As shown in FIG. 7, a penal 50 is provided with an upper glass substrate 51, an upper transparent electrode 52, a liquid crystal layer 53, a lower transparent electrode 54, an upper color filter film 55, a reflective layer 56 with a plurality of total-reflection regions 561 and apertures 562, a lower color filter film 57 and a lower glass substrate 58 in sequence, but no protective layer. FIG. 9 shows another penal 60, which is similar to the penal 50, except that a reflective layer 62 is provided to serve both function of passing light through and reflecting light.

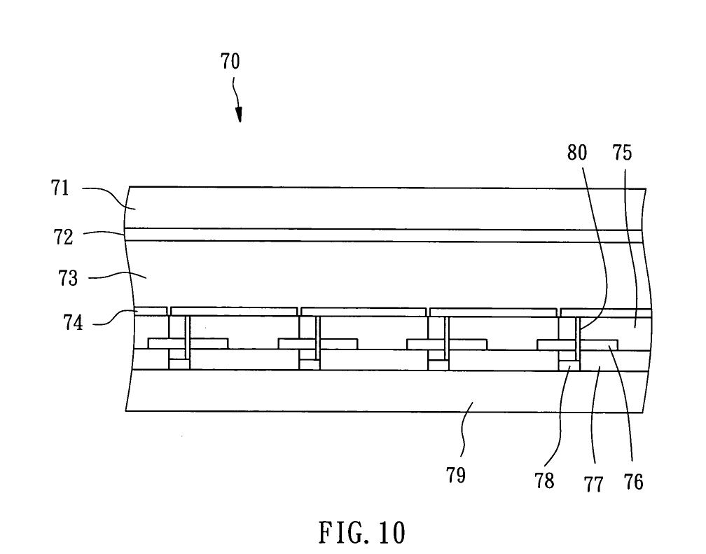

The present invention is applied to TFT-LCD too. As shown in FIG. 10, a TFT liquid crystal penal 70 has an upper substrate 71, an upper transparent electrode 72, a liquid crystal layer 73, a lower transparent electrode 74, an upper color filter film 75, a reflective layer 76, a lower color filter film 77, thin film transistors 78, a lower substrate 79 and conductive portions 80. The penal 70 still provides a higher color intensity and a greater luminance. The phase different And of the liquid crystal layer 73 is preferred in a range between 100 nm and 400 nm.

What is claimed is:

1. A liquid crystal penal, comprising an upper glass substrate and a lower glass substrate, between which a liquid layer, a filter layer and a reflective film are mounted, wherein the liquid layer is stacked on the filter layer and the filter layer has an upper color filter film and a lower color filter film and reflective film is provided at between the upper color filter film and the lower color filter film.

2. The liquid crystal penal as defined in claim 1, further comprising a protective layer on a top of the upper color filter film.

3. The liquid crystal penal as defined in claim 1, wherein the lower color filter film is made of a color resin material with higher color intensity and the upper color filter film is made of a color resin material with lower color intensity.

4. The liquid crystal penal as defined in claim 1, wherein the liquid crystal layer has a phase difference And in a range between 100 nm and 900 nm.

5. The liquid crystal penal as defined in claim 1, wherein the upper color filter film has a thickness in a range between 300 nm and 3000 nm and the lower color filter film has a thickness in a range between 300 nm and 3000 nm.

6. The liquid crystal penal as defined in claim 1, wherein the reflective film is stack on a top of the lower color filter film and the reflective film has a plurality of total-reflection regions and apertures.

7. The liquid crystal penal as defined in claim 6, wherein the reflective film has a thickness in a range between 10 nm and 1000 nm.

8. The liquid crystal penal as defined in claim 6, wherein the reflective film has an aperture ratio in a range between 5% and 80%.

9. The liquid crystal penal as defined in claim 1, wherein the reflective film covers a top of the lower color filter film totally and the reflective film passes light through and reflects light.

10. The liquid crystal penal as defined in claim 9, wherein the reflective film has a thickness in a range between 5 nm and 200 nm.

11. A method of making a liquid crystal penal, comprising the steps of:
a) providing a lower glass substrate;
b) providing a lower color filter film on the lower glass substrate, wherein the lower color filter film has red-light sensitive members, green-light sensitive members and blue-light sensitive members;
c) providing a reflective film on the lower color filter film for reflection;
d) providing an upper color filter film on the reflective film, wherein the upper color filter film has red-light sensitive members, green-light sensitive members and blue-light sensitive members;
e) coating a resin material on the upper color filter film to form a protective layer, wherein the protective layer has a flat surface;
f) providing a lower transparent electrode on the surface of the protective layer;
g) providing an upper glass substrate with an upper transparent electrode on a bottom thereof on the lower transparent electrode, and
h) providing a liquid crystal layer between the lower transparent electrode and the upper transparent electrode.

12. The method as defined in claim 11, wherein the reflective layer has a pattern having a plurality of total-reflection regions and apertures, which are formed by a photolithography method and etching.

13. The method as defined in claim 11, wherein the reflective film covers a top of the lower color filter film totally and the reflective film has a thickness in a range between 5 nm and 200 nm.

14. A method of making a liquid crystal penal, comprising the steps of:
a) providing a lower glass substrate;
b) providing a lower color filter film on the lower glass substrate, wherein the lower color filter film has red-light sensitive members, green-light sensitive members and blue-light sensitive members;
c) providing a reflective film on the lower color filter film for reflection;
d) providing an upper color filter film on the reflective film, wherein the upper color filter film has red-light sensitive members, green-light sensitive members and blue-light sensitive members;
e) providing a lower transparent electrode on the surface of the protective layer;
f) providing an upper glass substrate with an upper transparent electrode on a bottom thereof on the lower transparent electrode, and
g) providing a liquid crystal layer between the lower transparent electrode and the upper transparent electrode.

15. The method as defined in claim 14, wherein the reflective layer has a pattern having a plurality of total-reflection regions and apertures, which are formed by a photolithography method and etching.

16. The method as defined in claim 14, wherein the reflective film covers a top of the lower color filter film totally and the reflective film has a thickness in a range between 5 nm and 200 nm.
